(19) United States
(12) Patent Application Publication
(10) Pub. No.: US 2019/0102578 A1
(43) Pub. Date: Apr. 4, 2019

(54) System With Attack Protection Structure

(71) Applicant: NATIONZ TECHNOLOGIES INC., Shenzhen, Guangdong (CN)

(72) Inventors: Hua XIE, Shenzhen, Guangdong (CN); Juan LIU, Shenzhen, Guangdong (CN)

(21) Appl. No.: 16/079,563

(22) PCT Filed: May 12, 2017
(86) PCT No.: PCT/CN2017/084160

§ 371 Date: Aug. 24, 2018

(30) Foreign Application Priority Data
Jun. 24, 2016 (CN) 201610472061.7

(51) Int. Cl. G06F 21/87; G06F 21/78; G06F 21/85; G08B 23/00

(52) U.S. Cl. CPC G06F 21/87; G08B 23/00; G06F 21/85; G06F 21/78

(57) ABSTRACT

Provided is a system with an attack protection structure, including a plurality of memories, an analog unit and a digital unit. The system further includes a security protection alarm device. The security protection alarm device is suitable for detecting a laser and/or electromagnetic attack on the memories, the analog unit and the digital unit, and actively selecting a security protection measure when the attack is detected. The security protection alarm device of the system is timely started to operate after a system on a chip (SOC) is powered on, and the chip can efficiently give an alarm after being subjected to a security attack by lasers, electromagnetism, etc.

### TECHNICAL FIELD

The embodiments of disclosure relate to a system on a chip (SOC), and more particularly to a system with an attack protection structure.

### BACKGROUND

A memory is an important part of a SOC for information security, and it is also the focus of security attack protection. When the SOC for information security is subjected to a security attack by lasers, electromagnetism, etc, if attacked information can be timely obtained, the security attack may be more actively handled. The protection manner of a memory in the current SOC for information security is mainly implemented by adding Error Checking and Correcting (ECC) check bits.

The disadvantages of implementing security attack protection by adding ECC check bits mainly lie in:

high hardware overhead, wherein multiple check bits need to be added for a high-efficiency and high-reliability ECC check, and if there are few check bits, the probability of detecting an attack will be reduced;

high power consumption, wherein in general, power consumption is directly proportional to the increase of the ECC check bits, and is inversely proportional to memory read/write bit widths; and non-timely alarm, wherein only after reading stored information and performing corresponding processing, it can be determined whether a memory has been subjected to a security attack and whether data has been rewritten.

### SUMMARY

The embodiments of disclosure mainly aim to solve the technical problems that the security attack protection hardware is expensive, the power consumption is large and the alarm is not timely due to adoption of the existing manner of adding ECC check bits.

In order to solve the above technical problem, an embodiment of disclosure provides a system with an attack protection structure, including a plurality of memories, an analog unit and a digital unit, the system further includes a security protection alarm device;

the security protection alarm device is configured to detecting a laser and/or electromagnetic attack on the memories, the analog unit and the digital unit, and actively selecting a security protection measure when the attack is detected.

In an embodiment of the disclosure, the security protection alarm device includes a plurality of sensors and a sensor signal processing unit. Each sensor is provided in the corresponding memory, the analog unit and the digital unit. Each sensor is connected to the sensor signal processing unit.

Each sensor is configured to detect a laser and/or electromagnetic attack on the corresponding memory, the analog unit and the digital, unit, and transmit a detected attack state to the sensor signal processing unit;

the sensor signal processing unit is configured to actively select a security protection measure according to the attack state.

In an embodiment of the disclosure, all the sensors are linked together through a logical channel.

In an embodiment of the disclosure, there are one or more logical channels.

In an embodiment of the disclosure, each sensor includes a signal sampling mechanism, a signal processing mechanism, a sensor flag signal output module, and a signal input and control module;

the signal sampling mechanism senses an external attack laser and/or electromagnetic signal, and converts the sensed laser and/or electromagnetic signal to an electric signal, and the electric signal is sent to the signal processing mechanism;

the signal processing mechanism processes the electric signal, judges whether a SOC is subjected to a laser and/or electromagnetic attack, and sends an attack state to the sensor signal processing unit through the sensor flag signal output module;

when the SOC is powered on, the signal input and control module receives a reset signal of an external security protection system, sends the reset signal to the signal sampling mechanism and the signal processing mechanism respectively, and controls output of the sensor flag signal output module.

In an embodiment of the disclosure, an alarm flag is provided in the signal processing mechanism, when the signal processing mechanism determines that the SOC is subjected to a laser and/or electromagnetic attack, the alarm flag is set, and the set alarm flag is sent to the sensor signal processing unit through the sensor flag signal output module.

In an embodiment of the disclosure, the security protection measure includes resetting, interrupting and ignoring the current operation.

In an embodiment of the disclosure, the signal input and control module also accesses a test channel for early failure screening test of the sensor.

The embodiments of the disclosure have the following outstanding advantages over the existing manner of adding ECC check bits:

(1) A security protection alarm device starts to work immediately after a SOC is powered on, and can effectively give an alarm when the chip is subjected to a security attack such as a laser attack or an electromagnetic attack.

(2) After receiving an alarm signal of the security protection alarm device, the SOC for information security may adopt the manners of resetting, interrupting, and ignoring the current operation to timely handle the current security attack.

(3) Different memories use different alarm devices to facilitate the effective integration into a memory module so as to achieve the purposes of small layout area, low power consumption, timely alarm, and less false alarm.

The embodiments of disclosure are applicable to all memory-related solutions that have security protection requirements, and is also applicable to all other SOCs that have security protection requirements.

### BRIEF DESCRIPTION OF THE DRAWINGS

FIG. 1 is an overall structure diagram of an embodiment of the embodiments of disclosure;

FIG. 2 is a schematic block diagram of a sensor according to an embodiment of the embodiments of disclosure; and

FIG. 3 is a working flowchart of the embodiments of disclosure.

### DETAILED DESCRIPTION OF THE EMBODIMENTS

The embodiments of disclosure will now be described in further detail with reference to the accompanying drawings. These drawings are simplified schematic diagrams and illustrate the basic structure of the embodiments of disclosure only by way of illustration, so that only the configurations related to the embodiments of disclosure are shown.

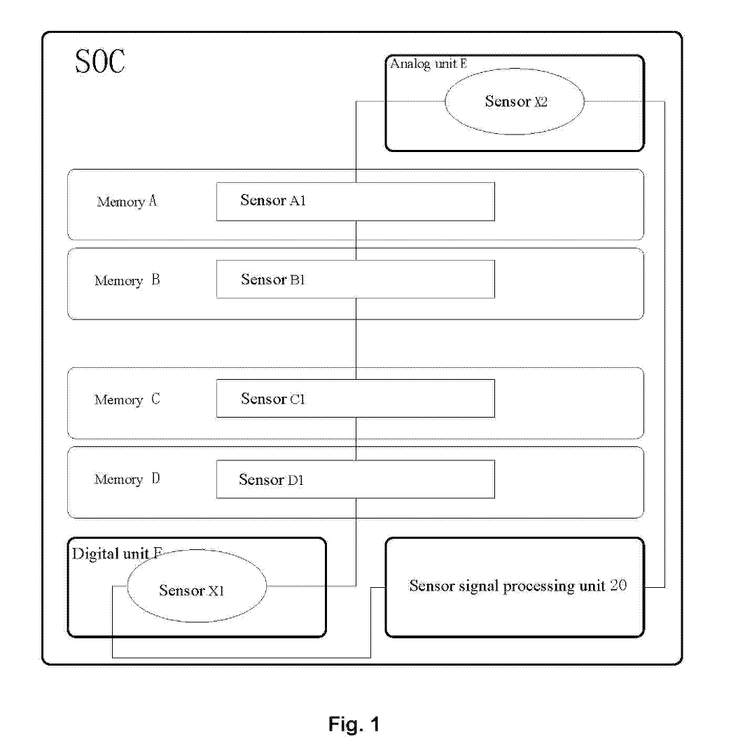

As shown in FIG. 1, a system with an attack protection structure provided in the embodiments of disclosure includes memories, A, B, C and D (not limited to these, but more), an analog unit E (not limited to this, but more), a digital unit F (not limited to this, but more), and a sensor signal processing unit 20. Each memory, the analog unit and the digital unit are provided with a sensor separately, that is, a sensor A1 is provided in the memory A, a sensor B1 is provided in the memory B, a sensor C1 is provided in the memory C, a sensor D1 is provided in the memory D, a sensor X2 is provided in the analog unit E, and a sensor X1 is provided in the digital unit F, wherein the sensor signal processing unit 20 and all the sensors A1, B1, C1, D1, X1 and X2 constitute a security protection alarm device. All the sensors A1, B1, C1, D1, X1 and X2 are linked together in series through one or more logical channels, and are connected to the sensor signal processing unit 20 through the logical channel.

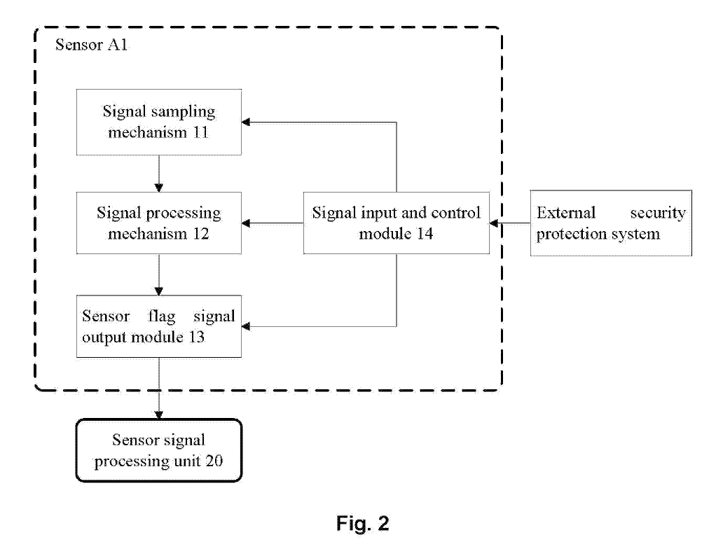

As shown in FIG. 2, the sensor A1 in FIG. 1 is taken as an example. Each sensor includes a signal sampling mechanism 11, a signal processing mechanism 12, a sensor flag signal output module 13, and a signal input and control module 14. Preferably, an alarm flag is provided in the signal, processing mechanism 12.

The signal sampling mechanism 11 senses an external attack laser and/or electromagnetic signal, and converts the sensed laser and/or electromagnetic signal to an electric signal, and the electric signal is sent to the signal processing mechanism 12. The signal processing mechanism 12 processes the electric signal, and judges whether a SOC is subjected to a laser and/or electromagnetic attack. When the signal processing mechanism 12 determines that the SOC is subjected to a laser and/or electromagnetic attack, the alarm flag therein is set, and the set alarm flag is sent to the sensor signal processing unit 20 through the sensor flag signal output module 13.

When the SOC is powered on, the signal input and control module 14 receives a reset signal of an external security protection system, sends the reset signal to the signal sampling mechanism 11 and the signal processing mechanism 12 respectively, and controls output of the sensor flag signal output module 13.

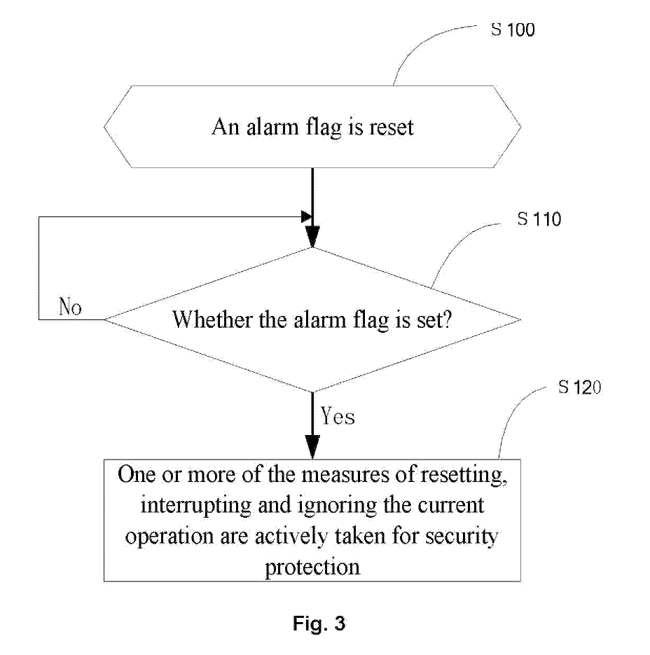

As shown in FIG. 3, during the working of the embodiments of disclosure, the following steps are generally followed:

in S100, when the alarm flag is reset, that is, the SOC is powered on, the signal input and control module 14 receives a reset signal of an external security protection system, sends the reset signal to the signal sampling mechanism 11 and the signal processing mechanism 12 respectively, and initializes the sensor to make the alarm flag in the signal processing mechanism 12 reset.

in S110, it is judged whether the alarm flag is set, that is, the signal processing mechanism 12 judges whether the alarm flag therein is set from a reset state, if the alarm flag is set, it is indicated that the SOC is subjected to an external laser and/or electromagnetic attack, if the alarm flag is not set, it is indicated that the SOC is not subjected to an external laser and/or electromagnetic attack, repeate the present judgment step;

in S120, the set alarm flag is sent to the sensor signal processing unit 20, for different attacks, the sensor signal processing unit 20 actively adopts a manner of resetting, interrupting and ignoring the current operation to perform security protection, and timely handles the current security attack.

Based on the above description of the ideal embodiments of the embodiments of disclosure, it is entirely possible for the relevant workers to make various changes and modifications without departing from the technical spirit of the embodiments of disclosure. The technical scope of the embodiments of disclosure is not limited to the contents of the specification, but the technical scope must be determined based on the scope of the claims.

What is claimed is:

1. A system with an attack protection structure, comprising at least one memories, at least one analog unit and at least one digital unit, the system further comprising a security protection alarm device, wherein
the security protection alarm device is configured to detect a laser and/or electromagnetic attack on the at, least one memories, the at least one analog unit and the at least one digital unit, and actively select a security protection measure when the attack is detected.

2. The system with an attack protection structure as claimed in claim 1, wherein the security protection alarm device comprises a plurality of sensors and a sensor signal processing unit, each sensor is provided in the corresponding memory, the analog unit and the digital unit, and each sensor is connected to the sensor signal processing unit;
each sensor is configured to detect a laser and/or electromagnetic attack on the corresponding memory, the analog unit and the digital unit, and transmit a detected attack state to the sensor signal processing unit; and
the sensor signal processing unit is configured to actively select a security protection measure according to the attack state.

3. The system with an attack protection structure as claimed in claim 2, wherein all the sensors are linked together through at least one logical channel.

4. (canceled)

5. The system with an attack protection structure as claimed in claim 2, wherein each sensor comprises a signal sampling mechanism, a signal processing mechanism, a sensor flag signal output module, and a signal input and control module;
the signal sampling mechanism senses an external attack laser and/or electromagnetic signal, and converts the sensed laser and/or electromagnetic signal to an electric signal, and the electric signal is sent to the signal processing mechanism;
the signal processing mechanism processes the electric signal, judges whether a system on a chip, SOC, is subjected to a laser and/or electromagnetic attack, and sends an attack state to the sensor signal processing unit through the sensor flag signal output module; and
when the SOC is powered on, the signal input and control module receives a reset signal of an external security protection system, sends the reset signal to the signal sampling mechanism and the signal processing mechanism respectively, and controls output of the sensor flag signal output module.

6. The system with an attack protection structure as claimed in claim 5, wherein an alarm flag is provided in the signal processing mechanism, when the signal processing mechanism determines that the SOC is subjected to a laser and/or electromagnetic attack, the alarm flag is set, and the set alarm flag is sent to the sensor signal processing unit through the sensor flag signal output module.

7. The system with an attack protection structure as claimed in claim 6, wherein the security protection measure comprises resetting, interrupting and ignoring the current operation.

8. The system with an attack protection structure as claimed in claim 5, wherein the signal input and control module also accesses a test channel for early failure screening test of the sensor.

9. The system with an attack protection structure as claimed in claim 8, wherein the security protection measure comprises resetting, interrupting and ignoring the current operation.

10. The system with an attack protection structure as claimed in claim 1, wherein the security protection measure comprises resetting,
interrupting and ignoring the current operation.

11. The system with an attack protection structure as claimed in claim 3, wherein each sensor comprises a signal sampling mechanism, a signal processing mechanism, a sensor flag signal output module, and a signal input and control module:
the signal sampling mechanism senses an external attack laser and/or electromagnetic signal, and converts the sensed laser and/or electromagnetic signal to an electric signal, and the electric signal is sent to the signal processing mechanism;
the signal processing mechanism processes the electric signal, judges whether a system on a chip, SOC, is subjected to a laser and/or electromagnetic attack, and sends an attack state to the sensor signal processing unit through the sensor flag signal output module; and
when the SOC is powered on, the signal input and control module receives a reset signal of an external security protection system, sends the reset signal to the signal sampling mechanism and the signal processing mechanism respectively, and controls, output of the sensor flag signal output module.

12. The system with an attack protection structure as claimed in claim 2, wherein the security protection measure comprises resetting, interrupting and ignoring the current operation.

13. The system with an attack protection structure as claimed in claim 3, wherein the security protection measure comprises resetting, interrupting and ignoring the current operation.
